(19) United States
(12) Patent Application Publication
(10) Pub. No.: US 2019/0056640 A1
(43) Pub. Date: Feb. 21, 2019

(54) Body mounted harness for flash photography that employs user's white shirt for a reflector

(71) Applicant: Elijah Vijaysheel Kakani, Lexington, KY (US)

(72) Inventor: Elijah Vijaysheel Kakani, Lexington, KY (US)

(21) Appl. No.: 15/681,346

(22) Filed: Aug. 19, 2017

(51) Int. Cl. G03B 15/06; G03B 15/03

(52) U.S. Cl. CPC G03B 15/06; G03B 15/03

(57) ABSTRACT

A flash photography reflector system where a harness that is mount on to the body of a user supports a photographic flash and is used in conjunction with a white shirt worn by the user, which is the principal reflector of the system. The harness comprises of two shoulder straps that support vertical beams that in turn bear a horizontal beam. The horizontal beam rests at the waist level of the user, on whom the harness is mounted. A photographic flash is attached to the horizontal beam of the harness, with its flash head facing the user's white shirt. Light emanating from the flash strikes the white shirt and is reflected off in a wider beam and illuminates the subject being photographed with a soft light in an aesthetically pleasing manner.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC

Not applicable.

### BACKGROUND OF INVENTION

The invention pertains to the general field of flash photography and in particular to the lighting of a photographic subject using a softer wider beam of light using a reflector device that modifies the direction, color and nature of light emanated from a source of light, so as to create a more aesthetically pleasing image of the subject.

Diffused or indirect light referred to as ‘soft light’ is used in still photography to light subjects remotely from the camera to illuminate a subject in a three dimensional, even and aesthetically pleasing manner. Diffused light is generally achieved using light modifiers such as soft boxes that encase a source of light within a box of various materials with a diffuser mounted on the front of the box that evenly disperses light onto the subject. Waltz, U.S. Pat. No. D692, 609, illustrates such a light modifier that is shaped in the form of an umbrella housing the source of the light. This modifier has a diffuser mounted on the front in order to create a wide, diffused soft beam of light.

Diffused ‘soft’ light can also be created using reflectors: devices that reflect a wider beam of light from a relatively small light source. This wider beam of light is then used to better illuminate subjects. Similar to diffusers, reflectors can also be used to alter the color, direction and intensity of the final light beam illuminating the subject as the circumstances of the project may require. Several types of light reflectors exist for photographic purposes. Shirilla, U.S. Pat. No. 9,103,522 discloses an umbrella shaped reflector for off camera soft lighting of a subject. Light from an off camera flash is intended to be bounced of the reflective inner surface of the umbrella shaped reflecting device on to a subject for even lighting. Similarly, Nussli et al., U.S. Pat. No. 4,807,089 describes a square umbrella-like reflecting device with struts within the frame of the device that help to mount it on a light source. The device is intended to reflect light emanating from the source into a wider beam. Several such off camera reflecting devices are available in the market. These devices, though effective, require supporting structures to anchor the reflectors off camera or helpers to prop them up in the appropriate position and can be an encumbrance to photographers wanting to move from one place to another swiftly, such as at a wedding photo shoot.

In order to circumvent the above problems, camera mounted reflectors have been invented. Kuntz, U.S. Pat. 7,645,046, discloses a camera mounted reflector system that is comprised of a pair of reflectors mounted onto a strut that engages the camera's flash shoe and is positioned in such a way that light from the camera's flash is reflected off the system in a wider beam than before thereby softening the lighting of the subject. Hughes, U.S. Pat. 7,360,909, discloses a portable, lightweight, foldable reflector that can be attached on to the photographic flash to reflect light emanating from the flash so as to create various effects. Though these innovations afford more portable solutions to reflect a wider and hence softer beam of light on to a subject, smaller surface areas compared to conventional light reflectors, limit them significantly unless light is further reflected off surfaces such as walls. Some of the camera mounted reflector systems may add additional weight to the camera itself impairing maneuverability and stability of the camera.

The present disclosure describes a novel light reflecting system and method that overcomes some of the short comings of above systems by employing a method of converting a white piece of clothing, such as a T-shirt worn by the photographer into a significant sized reflector that can cast a wide diffuse beam of light in order to aesthetically light subjects in low light situations. The harness that body-mounts a photographic flash obviates the need for additional equipment to mount reflectors off camera or on camera and affords greater mobility especially for photographers who like to shoot on the go. A lightweight appropriately shaped reflector can also be attached to the front of the photographer's body using the Velcro strips provided on the harness for creating similar effect as a further option.

### BRIEF SUMMARY OF THE INVENTION

The disclosure describes a novel photographic light reflecting system and method that employs a body-mounted harness that can be used to anchor a photographic flash device that converts a white T-shirt clad photographer himself/herself a light reflector. Advances in technology have led to the availability of powerful yet, light weight and portable flash devices. However, light cast on a subject from the small flash head of commonly used portable photographic flashes is notorious for its ‘harshness’. Lack of even, wide beamed smooth lighting leads to little, if any gray tones around the edges of the lighted subject, resulting in ‘flat’ looking, unenviable images. Reflecting light off walls can often circumvent the problem but this method leads to loss of directional control of light used for illuminating subjects and is limited by the availability of appropriate reflecting surfaces. Diffusers and reflectors remotely placed from the camera can create very pleasing aesthetic lighting effects but are limited in their portability and ease of use. This invention stems from the idea of employing a readily available reflecting surface which may be a white shirt worn by the photographer to throw soft, relatively controlled light on the subject being photographed with minimal equipment that does not have to be towed around or propped up by stands or helpers.

The present system is composed of a harness that is mounted on the body of the photographer. Two foam padded straps go over either shoulder and act as shoulder straps and contain enclosed malleable metal strips (for additional support and strength) that go over both the shoulders from the front to the back of the user acting to distribute the weight of the system evenly on the shoulders. A white layer of Rexene or similar materials invests these straps. A 2-inch wide belt made of tough material such as nylon or leather etc. goes around the waist of the user and is latched in place with a clip latch system. Nylon straps tether the shoulder straps to this waist belt behind the user running down vertically against the user's back. The principal component of the harness is a horizontal beam made of lightweight but tough materials such as aluminum, wood or plastic that rests at the level of the waist and forms a flat platform at the center that supports the photographic flash mounted on a cold shoe that is attached to the platform with a screw system. This horizontal beam is tethered to the aforementioned wide waist belt with struts made of the same materials as the horizontal beam. The weight of the flash needs to be further supported to prevent it from falling forward and away from the user. This is accomplished by two inverted ‘J’ shaped solid beams made of similar materials to the horizontal beam, that hang down and loop forward from the reinforced shoulder straps and prop up the horizontal beam that bears the flash by articulating with it in front of the user's hips on either side using brackets. The shoulder straps are further held in place by straps going around the arm pit that link at the back in such a way that the harness can be worn like a buttoned shirt by inserting arms under the shoulder straps on either side.

The harness forms a lightweight vest that not only leaves a major part of the front of the user unobstructed and supports the photographic flash in the center and front of the lower part of the body with the head of the flash facing the user. This harness is designed to be used with a white shirt worn by the user. The white colored shirt is intended to be the principal reflector of the system that reflects the light emanating from the flash in a wider beam onto the subject in front and in the vicinity of the photographer akin to a larger reflector. Alternatively, it can be used with an appropriately shaped reflector that can be mounted on the front of the body harness using Velcro provided on the front of the shoulder straps and the waist belt latch.

### BRIEF DESCRIPTION OF SEVERAL VIEWS OF THE DRAWINGS

FIG. 1 is a front view of the harness referred to herein, which has been mounted on to the body of a photographer. A photographic flash is shown attached to the horizontal beam of the harness at the waist to show its use with this harness.

FIG. 2 is a front view of the harness referred to herein showing all the various parts

FIG. 3 shows the left shoulder strap with a sectioned part of the left ‘J’ shaped vertical beam attached.

FIG. 4 shows a front view of the general structure of the right inverted ‘J’ shaped vertical beam component of the harness, in isolation. The central part of the beam has been sectioned out to fit the drawing the page.

FIG. 5 shows a front view of the general structure of the left inverted ‘J’ shaped vertical beam component of the harness, in isolation. The central part of the beam has been sectioned out to fit the drawing on the page.

FIG. 6 shows a front view of the waist-level horizontal beam component of the harness, in isolation. A cold shoe has been shown here to indicate the position where it screwed on to the beam.

FIG. 7 shows the front view of the waist belt component that has been latched closed. Sections of the lower ends of the ‘J’ shaped vertical beams are shown attached to the waist belt.

FIG. 8 shows the component of the harness that includes a strap mechanism with latches that loop around from the back of the user and under the armpits, to the front, to attach to the front ends of the shoulder straps pictured.

### DETAILED DESCRIPTION OF THE INVENTION

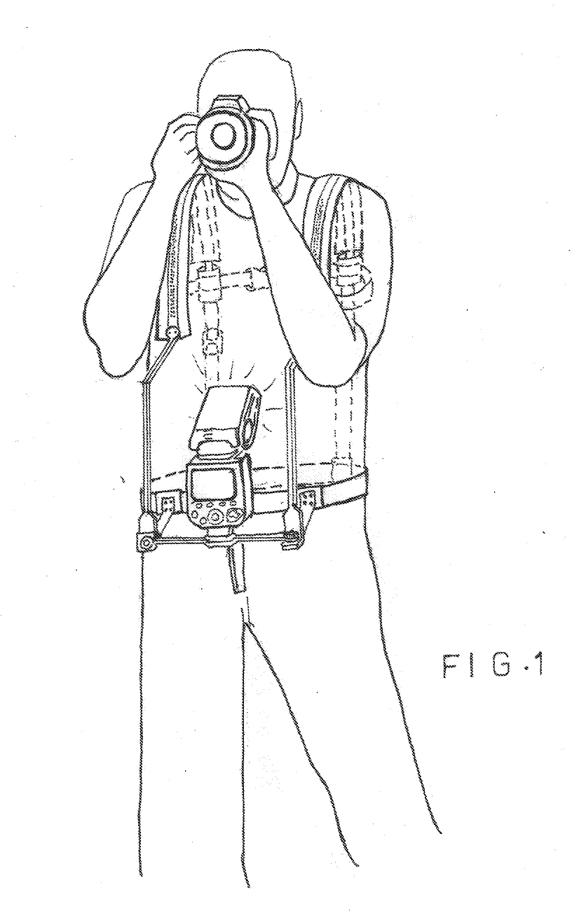

Referring to the figures, FIG. 1 illustrates the use of the body-mounted harness and demonstrates the way the harness is worn by the photographer. Note the use of the flash using this harness. The photographic flash is screwed on to the waist-level horizontal beam and faces the body of the photographer. Light emanating from the flash is intended to bounce out from the shirt worn by the photographer. The reflected light beam is wider and softer than that emanating directly from the flash and casts a soft wide beam of light on the subject to be photographed.

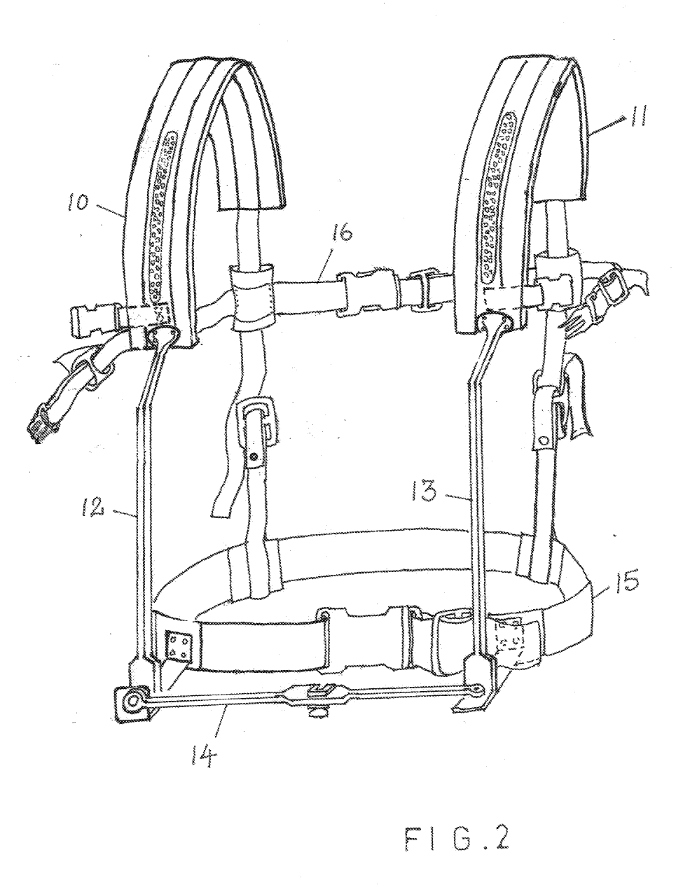

FIG. 2. Illustrates the harness with all its components as viewed from the front. It includes two shoulder straps that go over either shoulder of the photographer. The right shoulder strap, (from the perspective of the photographer) 10 and the left, 11 are intended to be worn over either shoulder of the photographer. Two vertical beams 12 and 13 that have a roughly inverted ‘J’ shape attach to the front ends of either shoulder straps and hang down the front of the body. The right vertical beam, 12, has a ‘W’ shaped end that forms an articulating surface for the horizontal beam, 14, on the front and is tethered or riveted to the waist belt, 15, towards the back or the body of the photographer. Similarly, the left vertical beam, 13, hangs down the front of the body of the photographer and forms an articulation surface on the front, as illustrated, which accepts the left end of the horizontal beam, 14, which can be screwed here. The vertical beam 13 is tethered or riveted to the waist belt, 15, using a plate that extends backward or towards the body of the photographer, as is illustrated and described in subsequent sections.

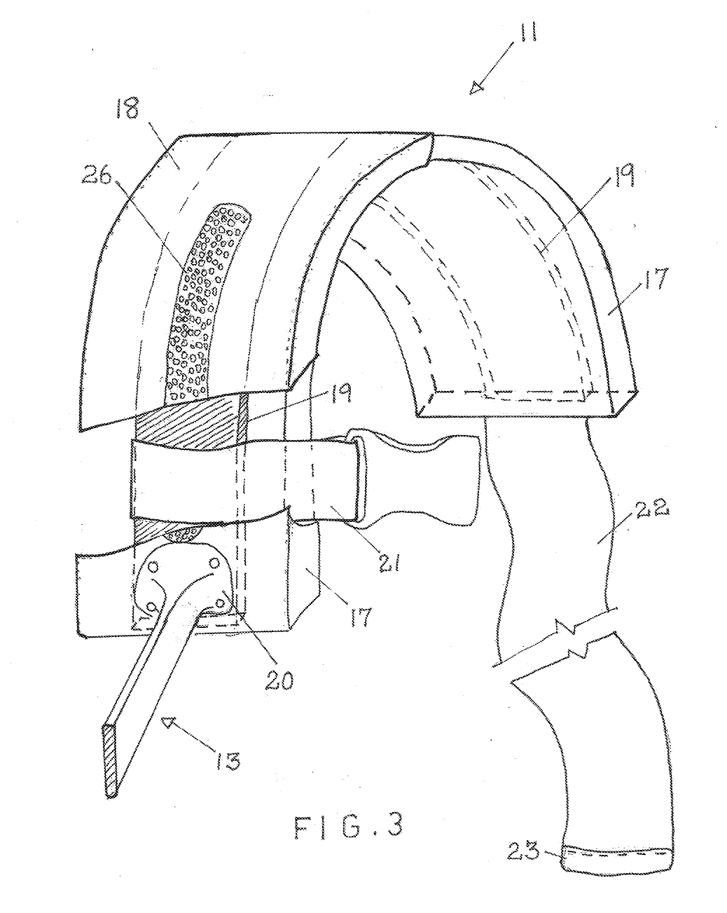

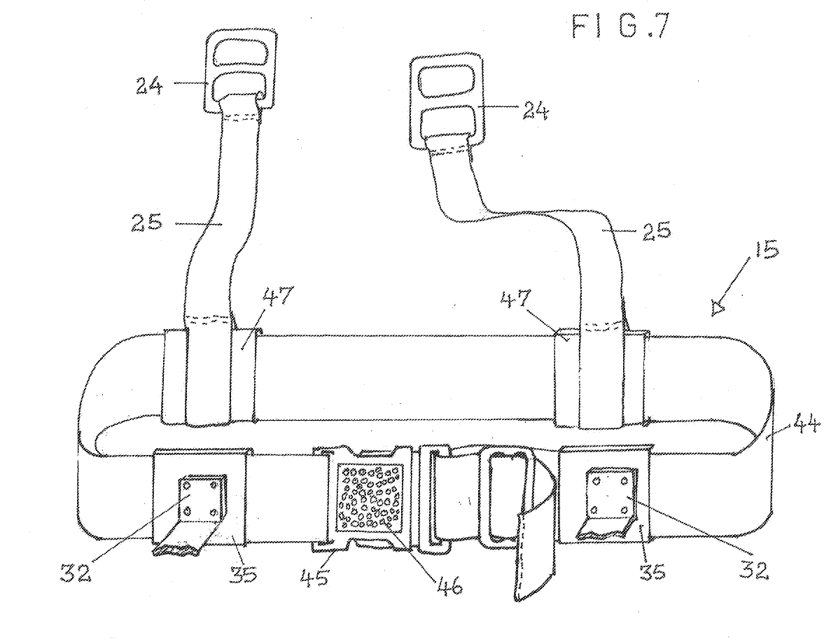

The shoulder straps, 10 and 11 are worn over either shoulder and are designed to distribute the weight of the harness evenly over the user's shoulders. Both shoulder straps have a similar structure and are mirror images of each other. The left shoulder strap is illustrated in FIG. 3. The interior of the shoulder strap has an approximately 2 inch or 5 cm wide pad made of foam or similar firm but pliable and soft materials. It is about 1.5 cm or so thick and is covered by sheath of tough white colored material such as Rexene or similar natural or synthetic materials. In FIG. 3., this sheath or covering layer is shown only partially to illustrate the inner components of the shoulder strap. As illustrated, a thin plate, 19, made of any malleable light metal such as aluminum or similar materials (malleable but firm and also light) lies inside the sheath, and runs across the outside and along the center of the foam pad within a groove in the foam pad. This plate serves to form a rigid supporting structure within the shoulder straps and prevents the remaining components such as the inverted ‘J’ shaped vertical beams from moving out of position during use. The plate, 19, is intended to be around 2.5 cm wide and about a millimeter or so thick but dimensions may vary according to the final size of the harness. The front end of the plate serves to form a firm base on to which the wide upper ends, 20 (called the head) of the vertical inverted ‘J’ shaped beams, 12 and 13, are riveted or screwed through the covering sheath on either shoulder straps. The portion of the inner plate, 19 above the area that attaches the vertical beam head, 20, has a loop of nylon strap, 21 looped around it within the investing Rexene sheath (18). This nylon strap, 21, emerges on the outer aspect of the shoulder strap between stitched ends of the Rexene sheath and bears a clip latch for articulation with the end of the strap, 16, that runs across the back of the user and comes forward under the armpit of the user, as pictured. Another nylon strap, 22 is stitched to the back end of the shoulder strap and is stitched on itself at the end, 23. This end, 23, is intended to attached to the loop attachment, 24 (see FIG. 7) at the end of the nylon straps, running up the back of the user from the waist belt, 15. The white sheathing Rexene layer, 18, of the shoulder straps, 10 and 11, is stitched neatly at the edges so as to cover all inner components including the foam pad, 17, malleable plate 19, and the looping inner part of the nylon strap, 21. It is designed to be white in color to aid in the reflection of light along with the user's shirt. A Velcro strap, 26, is stitched on to the front of either shoulder strap as pictured. This is intended to attach an optional reflector pad for use with the harness, if preferred.

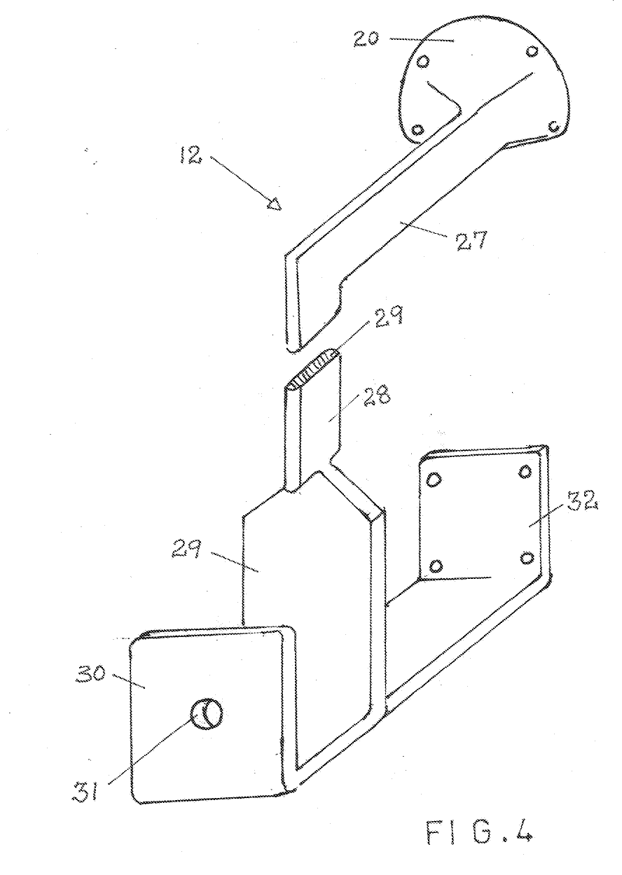

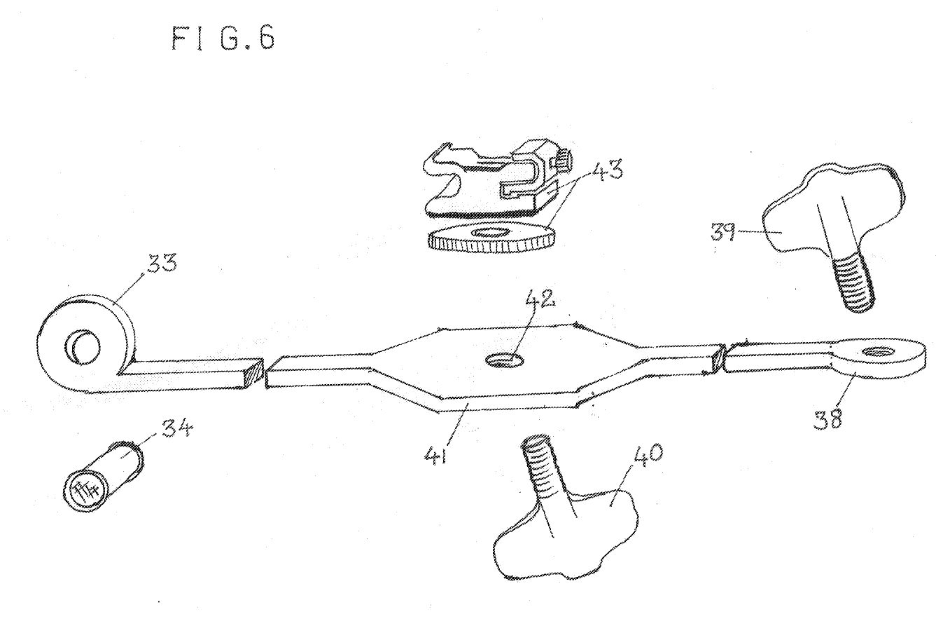

FIG. 4, illustrates the shape of the right inverted ‘J’ shaped vertical beam, 12, which forms a wide shield shaped structure called the head, 20 that attaches (by rivets or screws or other such means) to the front of the front end of the right shoulder strap, 10, as described above. This beam tapers down from the shield shaped head, 20, into a beam that has a roughly rectangular cross section, 29. The beam runs forward and down, 27, and then angulates or curves down (forming a roughly inverted ‘J’ shaped beam) into a vertical rod, 28, that is shaped lower down in to plate like structure that roughly has a ‘W’ shaped configuration, 29. The cross section of the beam, labeled 27 and 28, is rectangular and is about 1-2 cm wide and about 5 mm thick, at most, so as to present a narrow profile as viewed from front of the photographer, so as to minimize amount of shadow cast by it forwards from the photographer. The ‘W’ shaped plate at the lower end, 29, angulates forward and again up to form an articulating plate, 30, having dimensions of about 2.5×2.5 cm. This articulating plate, 30, has a hole in the center, 31, that is threaded and accepts a ¼″ (or 6.4 mm diameter) standard tripod screw (¼″-20). This hole, 31, is intended to articulate with the right end, 33 (see FIG. 6) of the horizontal beam, 14, with a ratcheted stud mechanism so as to provide graded and discontinuous movement. The horizontal beam, 14, has been designed such that it can be rotated up and down along a plane perpendicular the long axis of the articulating stud, 34, (see FIG. 6). The ‘W’ shaped plate, 29, at the lower end of the vertical beam extends backward too and then upwards to form another flat plate like surface, 32, that can be riveted or screwed or stuck or welded on to a metallic (or firm plastic) rectangular sheath, 35 (see FIG. 7) appropriately positioned over the waist belt, 15. The vertical inverted ‘J’ shaped beams, 12 and 13, are to be made of hard but light materials such as aluminum or wood or plastic or fiber or similar such materials. It has to be understood that the design of the articulations, sizes of articulating structures such as screws, described in the above section and elsewhere in the text can vary within the scope of the general design of this harness.

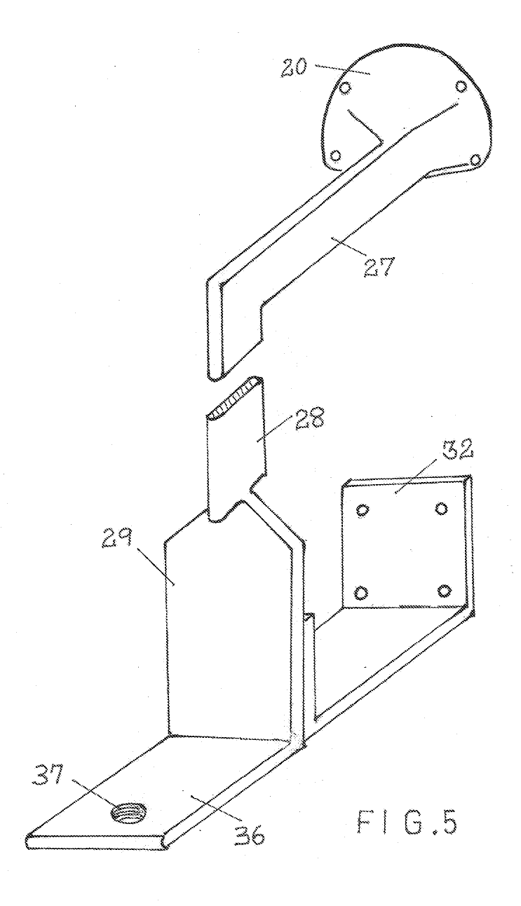

The left inverted ‘J’ shaped vertical beam, 13, also attaches to the front end of the left shoulder strap, 11, and has a similar design and structure to the right inverted ‘J’ shaped vertical beam, 12, as described above. The only major difference is that the left beam, as illustrated in FIG. 5, has a different shaped lower end which is shaped like an ‘F’ rather than a ‘W’ i.e., it has a lower flat plate, 29 that then angulates forward but does not turn up, rather forms the flat plate, 36 as illustrated that is rectangular shaped with dimensions of about 7.5 cm×2.5 cm. This plate, 36, has a screw hole, 37, (about ⅔rds distance forward from the back end of plate labeled 36) that accepts a ¼″ (6.4 mm diameter) male screw and is intended to articulate with the left end, 38 (see FIG. 6) of the horizontal beam, 14. The sloping upper part of the inverted ‘J’ shaped beams, 27, measure about 5″ (12.5 cm) in length and forms an angle of about 53 degrees to the vertical at the attachment to the shoulder strap so as to position the vertical portion of the beam, 28, (see FIGS. 2, 4 and 5) about 4 inches away and in front of the user. The lower part of the vertical beam, 28, is intended to be roughly about 25 cm (10 inches) long (variable, based on size of harness).

The horizontal beam, 14, that runs at the level of the waist and in front of the photographer is the component of the harness that supports a backward-facing photographic flash as illustrated in FIG. 1. Its parts are illustrated in FIG. 6. As described above, its right end, 33, (from the perspective of the photographer) forms a wide ring like structure that articulates with the flat plate, 30 of the right vertical inverted ‘J’ shaped beam as illustrated, using a stud, 35. This stud, 35 (FIG. 6) is grooved and intended to provide a ratcheted discontinuous movement to the horizontal beam. The beam rotates in the plane perpendicular to the long axis of the stud, 35 i.e., in the same plane as the front surface of the user's shirt (also called coronal plane, in human anatomic terminology). In view of the fact that the vertical inverted ‘J’ shaped beams are positioned about 4 inches or 10 cm in front of the user and due to the lower ends of these beams bending forward, and running another 2 inches or 5 cm (at least), the horizontal beam will be positioned about 6 inches or 15 cm forward from the user's waist so that there is enough room for the beam of light shining back from the attached photographic flash light to spread widely before it hits the surface of the user's shirt or a mounted optional reflector (using provided Velcro straps) before being reflected forward (as illustrated in FIG. 1). As illustrated in FIG. 6 the left end, 38, of the horizontal beam articulates with the part, 36, at the screw hole, 37, of the left vertical beam. This end is also shaped like a thick ring but is positioned, as drawn, in the horizontal plane (perpendicular to the right end, 33). A male screw, 39, measuring ¼″ (6.4 mm) in diameter with a wide handle helps secure the horizontal beam to the plate, 36, at screw hole, 37.

The central part of the horizontal beam, 41, is flattened and widened and holds a screw hole, 42, that accepts another male screw, 40, measuring ¼″ (6.4 mm) in diameter and of appropriate length so as to secure a cold shoe, 43, such as made by several third party providers (such as Neewer, registered trade mark, or LimoStudio, registered trade mark). The cold shoe, 43, is the component that attaches to the photographic flash.

The waist belt component, 15, of the harness is composed of a tough pliable belt, 44, (about 2 inches or 5 cm wide) made of nylon or leather or cotton or similar such materials and is latched in front of the user using a clip-latch or similar such mechanism, 45. It has 4 rectangular sleeves, labeled, 35, on either side in the front and 47, on either side in of the back. The rectangular sleeves, 35, 47 are about 5.2 cm in height (just over 2 inches) and around 5 cm (2 inches) wide and are designed to allow free movement of the belt within the sleeve. They are to be made of hard materials such as metal or plastic or fiber. The front rectangular sleeves, 35 attach the parts of the vertical inverted ‘J’ limbs on either side labeled 32 as illustrated in FIGS. 2 and 7. The rectangular sleeves, 47, at the back of the waist belt have looped nylon straps around them that run up the lower back of the user and have loops, 24, at the end that accept the nylon straps, 22, emanating from the back ends of the shoulder straps on either side of the upper back of the user, as illustrated in FIG. 2.

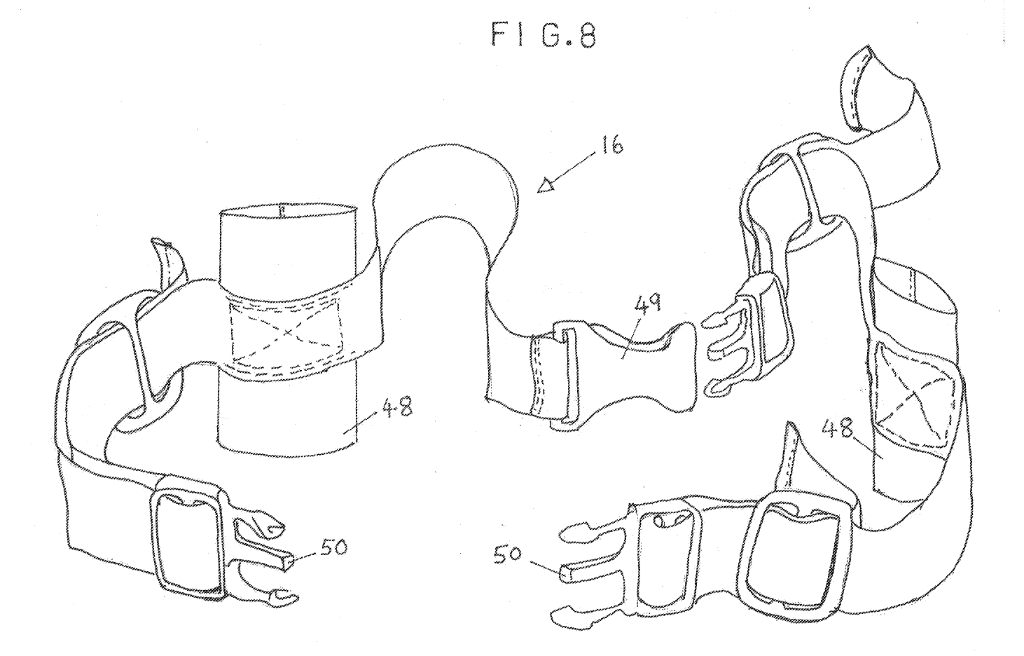

The back of the harness is secured in position using a horizontally running nylon strap mechanism 16, illustrated in FIG. 2 and detailed in FIG. 8. It consists of left and right straps as pictured that each has a sleeve, 48, made of tough material such as leather or Rexene etc., through which run the vertical nylon straps coming down from the back of the shoulder straps labeled 22, (see FIG. 3). The nylon straps forming the component 16, run forward and their ends, 50, articulate with the latches on the sides of the front of the shoulder straps, 21 (FIG. 3) using a clip-latch mechanism, as pictured.

The harness straddles both shoulders and locks around the waist of the user at the waist belt and supports the vertical (12,13) and horizontal (14) beams as described above that support the photographic flash. The photographic flash rests in the center and at the level of the waist over the horizontal beam as described above about 15 cm (6 inches) away from the user such that the flash head and thus the light emanating from the flash points towards the user's white shirt or an optional (appropriately shaped) photographic reflector that is mounted in front of the user's shirt using Velcro straps provided on the harness, 26 and 46, (separate patent to be applied for the reflector). When the flash is triggered the light emanating from the flash bounces off the user's white shirt or the reflector and is reflected forward in a wide beam and casts a soft light on to the subject being photographed so as to aesthetically light the subject for the photograph.

What is claimed is:

1. A flash photography reflector system made up of a body mounted harness worn by the user that is intended to bear a photographic flash at the level of the waist of the user, with the flash head pointing towards the user in order to use the user's shirt as the principal reflector of the system

2. The body mounted harness of claim 1, that comprises of two shoulder straps made of padding made of soft materials such as foam or rubber and are covered by a tough sheath of material made of materials such as Rexene.

3. The body mounted harness of claim 1, that comprises of two shoulder straps made of soft padding materials such as foam or rubber that have a flat malleable plate running over the padding materials so as to provide added structural support and all of which are covered by a tough sheathing material such as Rexene.

4. The body mounted harness of claim 1, that comprises of two vertical inverted ‘J’ shaped solid beams attaching to the front ends of the shoulder straps and running down the front of the user and have at the lower end surfaces that attach to the horizontal beam, the beams being made of solid and light weight materials.

5. A flash photography reflector system made up of a body mounted harness worn by the user that is intended to bear a photographic flash at the level of the waist of the user, with the flash head pointing towards the user, that employs a plain reflector attached to the front of the harness as the principal reflector of the system.

6. The body mounted harness of claim 5, where two shoulder straps straddling both shoulders that are attached on the front end to two vertical solid beams.

7. The body mounted harness of claim 5, where the two vertical solid beams that either angulate or curve forward assuming a roughly inverted ‘J’ shape and extend down the front of the user's body extending down from and being attached to the front ends of the shoulder straps.

8. The body mounted harness of claim 5, where horizontal beam that articulates with the two vertical aforementioned beams and has a plate in the central part with an attachment for a cold shoe.

9. The body-mounted harness of claim 5, with a waist belt that attaches to the vertical beams at their lower ends and further supports the horizontal beam assembly and the flash mounted thereon.

10. The body mounted harness of claim 5, with straps that attach the shoulder straps behind the photographer's back, to each other and to the front ends of the shoulder straps and further to the waist belt lower down, so as to provide added stability to the harness.
